(19) United States
(12) Patent Application Publication
(10) Pub. No.: US 2004/0169922 A1
(43) Pub. Date: Sep. 2, 2004

(54) Stereo microscopy

(76) Inventors: Tony Wilson, Oxford (GB); Mark Andrew Aquilla Neil, Oxford (GB); Rimvydas Juskaitis, Oxford (GB)

Correspondence Address: STEINBERG & RASKIN, P.C., 1140 AVENUE OF THE AMERICAS, 15th FLOOR, NEW YORK, NY, 10036-5803, US

(21) Appl. No.: 10/473,263

(22) PCT Filed: Mar. 7, 2002
(86) PCT No.: PCT/GB02/01019

(30) Foreign Application Priority Data
Mar. 29, 2001 (GB) 0107857/5

(51) Int. Cl. G02B 27/22

(52) U.S. Cl. 359/462

(57) ABSTRACT

A method of stereo microscopy involves using an apparatus including a microscope (2), a sample holder (4) located in the vicinity of the focal point of the microscope, drive means (18) for providing relative movement between the sample holder and the focal point, an image gathering device (10) arranged to collect microscopic images of objects at the focal point of the microscope, an image processing device (20) and a display device (22). First and second microscopic images of an object in the sample holder are gathered by the image gathering device (10) by means of first and second sequential exposures, relative movement between the sample holder and the focal point being provided in first and second directions during said first and second exposures respectively. The first and second images are processed by the image processing device (20) and the processed first and second images are displayed substantially simultaneously by the display device (22) for viewing separately by the left and right eyes respectively of an observer.

The present invention relates to a stereo microscope apparatus and a method of stereo microscopy. In particular, but not exclusively, the invention relates to a high resolution stereo microscope and method of microscopy.

Conventional stereo microscopes have binocular eyepieces, both of which are arranged to view the object through a single objective lens. The optical axes of the light paths for the two eyepieces are laterally displaced from one another at the point where their pass through the objective lens. This produces viewing parallax for the two eyes, which is interpreted by the brain as a stereo or three dimensional image.

Conventional stereo microscopes work very well at low and medium resolutions, down to a few microns. However, at higher resolution, two problems appear. First, because the optical axes of the two light paths are displaced to either side of the centre of the objective, the effective aperture of the objective is reduced, which reduces the resolution of the microscope. Second, and perhaps more importantly, because the actual aperture of the objective lens is large, the depth of focus at high resolutions is very shallow, leading to a “sectioning” effect. Depth information, interpreted from a lateral shift between the left and right images, is therefore lost, leading to a reduced stereo effect.

It is an object of the present invention to provide a stereo microscope and a method of stereo microscopy that mitigates at least one of the aforesaid problems.

According to the present invention there is provided a method of stereo microscopy, using an apparatus including a microscope, a sample holder located in the vicinity of the focal point of the microscope, drive means for providing relative movement between the sample holder and the focal point, an image gathering device arranged to collect microscopic images of objects at the focal point of the microscope, an image processing device and a display device, wherein first and second microscopic images of an object in the sample holder are gathered by the image gathering device by means of first and second sequential exposures, relative movement between the sample holder and the focal point being provided in first and second directions during said first and second exposures respectively, the first and second images are processed by the image processing device, and the processed first and second images are displayed substantially simultaneously by the display device for viewing separately by the left and right eyes respectively of an observer.

The term “focal point” as used herein is defined as the point where the optical axis of the microscope passes through the focal plane of the objective lens. This point serves as a reference point for defining the directions of relative movement between the sample holder and the microscope.

The present invention enables virtually real time generation of high definition stereo microscopic images, with a relatively large depth of field. The invention does not suffer from the problems associated with a reduced effective aperture of the objective lens, and provides an improved stereoscopic effect.

Advantageously, said first and second directions of relative movement are non-parallel. The directions of relative movement may be inclined at an angle β in the range 0° to 20°, preferably 5° to 15°, more preferably approximately 10°. Preferably, the angle β is adjustable. The allows the magnitude of the stereoscopic effect to be controlled.

Advantageously, each of said first and second directions includes a component in the axial direction of the microscope. Relative movement in the axial direction may be provided by moving the sample holder or alternatively by moving the focal plane of the microscope. Preferably, the distance of relative movement in the axial direction is greater than the depth of field of the microscope. Relative movement in the axial direction has the effect of increasing the apparent depth of the image considerably beyond the depth of focus.

Advantageously, at least one of said first and second directions includes a component in the lateral direction of the microscope. Relative movement in the lateral direction may be provided by moving the sample holder or alternatively by moving the optical axis of the microscope. Preferably, the distance of relative movement in the lateral direction is greater than the resolution of the microscope. Different relative movement in the lateral direction during the two exposures provides the stereoscopic effect.

Advantageously, an inverse filtering process is applied to the first and second images. The inverse filtering process may include the steps of generating a Fourier transform of the image, applying an inverse filter, and then generating an inverse Fourier transform. The inverse filter preferably comprises a Wiener filter. The inverse filtering process is preferably carried out by means of a data processing device. This process reduces the effect of out of focus blur and increases the contrast of the image.

Alternatively, a digital image restoration process may be applied to the first and second images. The digital image restoration process may be applied in the spatial domain, for example by convolution or the use of unsharp masks.

Advantageously, relative movement between the sample holder and the focal point is controlled by a computer, to generate stereoscopic images automatically.

The processed first and second images may be separated physically from one another for separate viewing. For example, the images may be printed or displayed as a stereo pair and viewed using stereo spectacles.

Alternatively, the processed first and second images may be separated optically from one another for separate viewing, for example by displaying the images as an anaglyph and viewing them through coloured glasses, or by using polarised light and polarising filters, or a lenticular display.

Alternatively, the processed first and second images are separated temporally from one another for separate viewing, for example by showing both images alternately and viewing them through spectacles having synchronised alternating shutter mechanisms.

According to a further aspect of the invention there is provided a stereo microscopy apparatus including a microscope, a sample holder located in the vicinity of the focal point of the microscope, drive means for providing relative movement between the sample holder and the focal point an image gathering device arranged to collect microscopic images of objects at the focal point of the microscope, an image processing device, a display device and a control device that is constructed and arranged to control operation of the apparatus, said control device being programmed such that during operation, first and second microscopic images of an object in the sample holder are gathered by the image gathering device by means of first and second sequential exposures, relative movement between the sample holder and the focal point is provided in first and second directions during said first and second exposures respectively, the first and second images are processed by the image processing device, and the processed first and second images are displayed substantially simultaneously by the display device for viewing, separately by the left and right eyes respectively of an observer.

Advantageously, the control device is programmed such that during operation, said first and second directions of relative movement are non-parallel. Preferably, the first and second directions of relative movement are inclined at an angle β, and the apparatus includes means for adjusting the angle β.

The apparatus may include means for moving the sample holder and/or the focal plane and/or the optical axis of the microscope.

The image processing device may be constructed and arranged to apply an inverse filtering process or a digital image restoration process to the first and second images. Advantageously, the image processing device comprises a data processing device.

The display device may be constructed and arranged such that the processed first and second images are separated physically, optically or temporally from one another for separate viewing.

An embodiment of the invention will now be described, by way of example, with reference to the accompanying drawings, in which:

FIG. 1 is a schematic diagram of a microscope and stereoscopic imaging system;

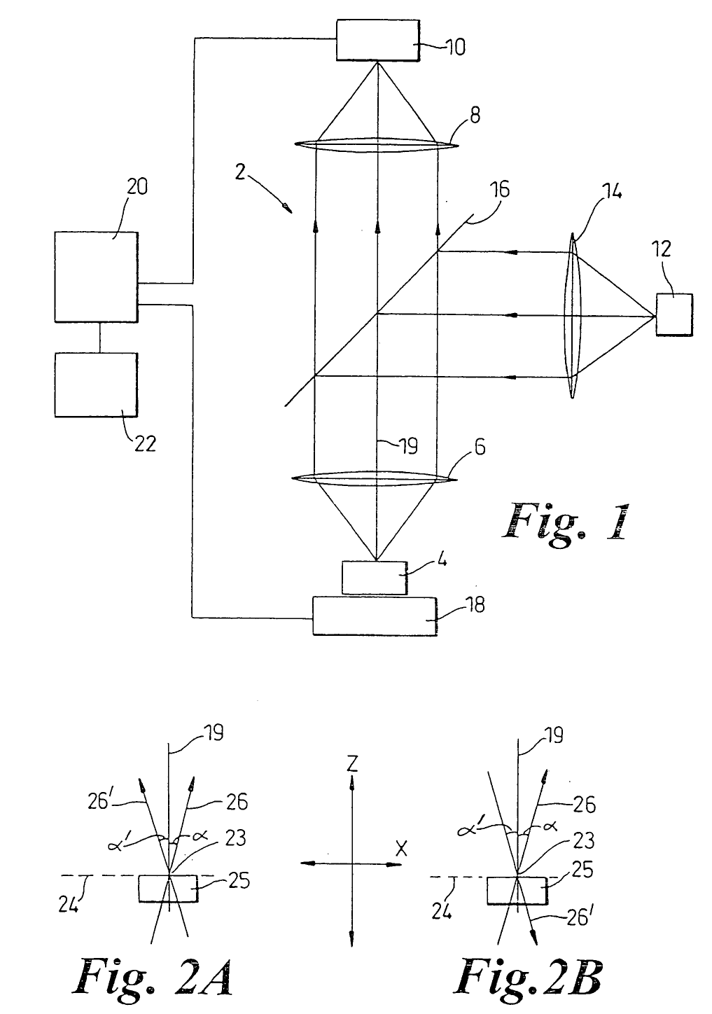

FIGS. 2a and 2b are side views illustrating the movement of a sample below the objective lens of a microscope, and

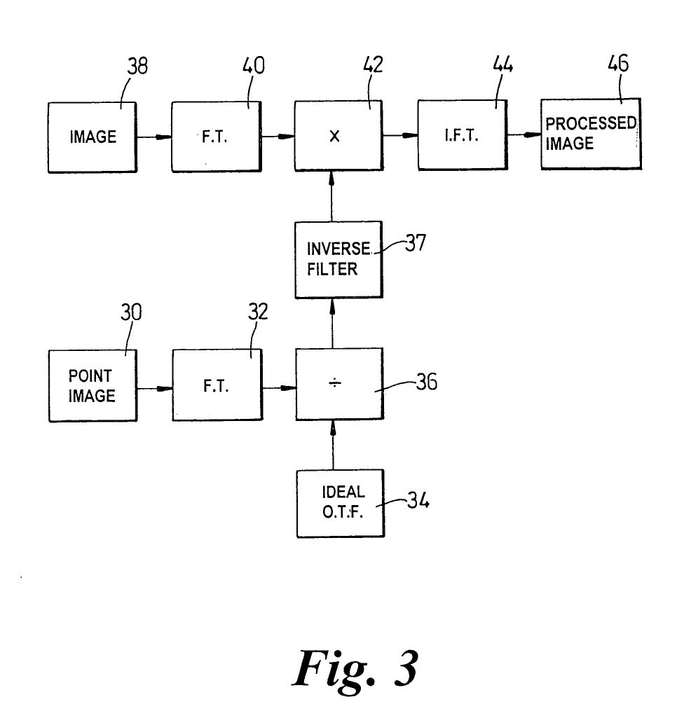

FIG. 3 illustrates the steps of an image processing algorithm employed in the invention.

The invention involves the use of a high resolution microscope 2, an example of which is shown schematically in FIG. 1. The microscope 2 includes a sample holder 4, an objective lens 6, and a tube lens 8 that focusses a image onto a CCD camera 10. Light from a light source 12 passes through a collimating lens 14 and is introduced into the optical path of the microscope via a beam splitter 16, and is focussed into the sample holder 4 by the objective lens 6. Alternative lighting and imaging arrangements may be provided, including transmission and reflection brightfield, darkfield, phase contrast, differential interference contrast and fluorescence, each of which can be in full colour. All of the aforesaid components are entirely conventional and will not be described in further detail.

The sample holder 4 is mounted on a translation stage 18 that allows rapid and precise movement in the x- and z- directions, where the z-axis is parallel to the optical axis 19 of the microscope and the x-axis is orthogonal. Movement of the translation stage may for example be driven by piezo-electric transducers, and is controlled by a computer 20, for example a PC. The computer is also connected to the CCD camera 10 to receive and process images captured by the camera. The computer is also connected to an output device 22 that allows the images to be viewed. The output device may for example be a computer screen, a pair of stereoscopic viewing goggles, a printer or some other display device.

A method of generating high resolution stereo microscope images using the apparatus shown in FIG. 1 will now be described.

The method involves capturing two images by means of sequential photographic exposures using the microscope 2 and the CCD camera 10, and recording the images produced by those exposures in the computer 20. The two images correspond to the left eye and right eye views of the object in the sample holder 4. The two images are processed by the computer then displayed substantially simultaneously to the two eyes of the viewer, creating a stereoscopic image.

During each of the two exposures, the sample holder 4 is moved relative to the focal point 23 of the microscope by means of the translation stage 18. The term “focal point” is defined as being the point where the optical axis 19 of the microscope passes through the focal plane 24 of the objective lens 6. The focal point 23 serves as a reference point for defining the directions of relative movement between the sample holder and the microscope.

Each image captured by the camera 10 comprises an integration of the light entering the camera during the exposure, and therefore includes all the optical information gathered during that exposure, although much of that information will be blurred and difficult for the eye to interpret.

The movement of a sample 25 in the sample holder 4 relative to the objective lens 6 during each exposure is linear and includes components in the directions of the z- and x-axes. As illustrated in FIG. 2a, the directions of these two movements, which are illustrated by the arrows 26 and 26′, are at opposite acute angles α, α′ to the optical axis 19 of the microscope (the z-axis). The directions of movement are therefore separated by an angle β, where β=α+α′.

The directions of these movements may however be varied. For example, as shown in FIG. 2a, during the first exposure the direction of movement 26 is in the positive z-direction and the positive x-direction, whereas during the second exposure the direction of movement 26′ is in the positive z-direction and the negative x-direction. Alternatively, as shown in FIG. 2b, the directions of movement may be chanced so that during the first exposure the direction of movement 26 is in the positive z-direction and the positive x-direction, whereas during the second exposure the direction of movement 26′ is in the negative z-direction and the positive x-direction. The result will of course be the same in both cases.

The microscope has a very shallow depth of field and, in general, the distance the sample 25 moves in the z-direction of the z-axis will be considerably greater than the depth of focus. That component of the movement will therefore have the effect of moving the sample through the focal plane of the microscope and (generating a composite image that consists effectively of an integrated set of superimposed images representing sections through the sample on a plane that is perpendicular to the z-axis.

This method of building up a composite image is similar in some respects to the method of increasing the depth of focus of a mono microscope described by G. Hausler (“A method of increasing the depth of focus by two step image processing”, Opt. Commun., 6, 38-42 (1972)), which is incorporated by reference herein. In that method, a three dimensional object is moved through the focal plane of the objective along the optical axis of the microscope, and a integrated image is captured, for example by means of a single exposure using, a film or CCD camera. Since every part of the object passes through the focal plane, a sharp image of the entire object is produced, albeit with a significant amount of background light that is produced bid the out of focus parts of the object, which tends to reduce the contrast of the image. This background light can however be reduced subsequently bad image processing techniques.

The second component of the movement in the direction of the x-axis introduces a lateral shift that is superimposed on the axial movement resulting from the z-component of the movement. Since the direction of the x-component is reversed for each of the two exposures, this produces the effect of parallax, whereby the object is viewed from two different angles generating slightly different images. These two different images when seen separately using the left and right eyes are interpreted by the brain as a stereoscopic image, diving the image of a three dimensional object the impression of depth.

The direction and distance of movement during the two exposures will of course depend on the resolution of the microscope, the size of the sample and the desired magnitude of the stereoscopic effect. The movement is controlled by the computer 20 according to these requirements. As a typical example, where the microscope is capable of resolving features having a lateral dimension of about 0.5 μm, the axial movement (in the direction of the z-axis) may be about 10 μm and the angular separation β between the two axes of movement may be about 10°.

The size of the angle β will determine the strength of the stereoscopic effect, a larger angle producing a more powerful effect. However, if β is too large, the brain will not be able to process the images correctly, and for practical purposes the angle β will generally lie in the range 0° to 20°.

As mentioned above, the images captured by the camera include out of focus blur as well as a sharply focussed image of the object in the sample holder. The main effect of the blur is to reduce the contrast of the image. However, because the blur consists mainly of low spatial frequencies, it can be largely, removed by applying an inverse filter in the frequency domain. This is achieved by means of digital processing of the image in the computer.

The process typically entails creating a Fourier transform of the image, multiplying this by an inverse filter (for example a Wiener filter) and then performing the inverse Fourier transform. The inverse filter may be calculated theoretically or inferred from measurements made on test samples. This filter will have to be modified (or scaled) when a different lens is used or the depth of field is changed.

The steps of the image processing algorithm are illustrated schematically in FIG. 3. First, the inverse filter is created by taking a point image 30 and generating the Fourier transform 32 of that image. An ideal optical transfer function 34 is then divided 36 by the Fourier transform 32 to generate the inverse filter 37. Next, an image 38 of a sample is captured by the camera 10 and fed to the computer 20. The Fourier transform 40 of that image is generated and this is multiplied 42 by the inverse filter 37, which boosts the high spatial frequencies with respect to the low spatial frequencies that represent the background light or blur in the captured image. The inverse Fourier transform 44 of the filtered data is then generated, creating the processed image 46.

The digital image processing method can be carried out very quickly in an ordinary PC, producing processed stereoscopic images at the video rate of 25-30 Hz.

The output device 22 may generate stereoscopic images in a variety of different ways. For off-line viewing, a stereo pair or anaglyph (two colour) image can be printed and then viewed using, respectively, a stereo viewer or red/green spectacles. Alternatively, the images may be viewed in a real time environment using a stereo display of some kind. This may, for example, use stereoscopic googles that display the left- and right-eye images on separate video screens, or it may include a single video display and means for separating the images intended for the two eyes, for example by using two-colour spectacles, polarised light, alternating images and goggles with synchronised electronic shutters, lenticular displayes and so on.

Various modifications of the method are possible, some of which will now be described.

Most importantly, while in the example described above the sample is moved physically relative to the microscope, it is entirely possible to achieve the same result without actually moving the sample. Thus, as regards movement in the z-direction (in the direction of the optical axis of the microscope), the invention only requires that there is relative movement between the sample and the focal plane of the microscope: i.e. the sample moves through the focal plane or the focal plane moves through the sample. Therefore, instead of moving the sample, the microscope may be continuously refocused, so that the focal plane moves steadily through the sample. This may be achieved for example by using a piezo-electric objective lens focussing device, a membrane mirror or a liquid crystal lens.

Similarly, as regards movement in the orthogonal x-direction, the invention only requires that there is relative movement in that direction between the sample and the optical axis of the microscope. This can be achieved either by moving the sample relative to the microscope, or by translating the optical axis of the microscope optically, for example by moving or rotating a reflective or refractive optical element positioned in the light path of the microscope, or by moving the CCD chip or electronically shifting the charge image across the CCD chip. Alternatively, if a membrane mirror or a liquid crystal lens is provided, this may be adjusted to generate lateral movement of the optical axis. Since axial movement can also be generated using these devices (as described above), it is possible to implement both axial and lateral movement using a single device.

Further, to generate a stereo image, the only requirement is that the directions of relative movement during the taco exposures are not aligned. It is not essential for both directions of movement to be inclined relative to the optical axis of the microscope. Instead, one of those directions may be inclined relative to the optical axis whereas the other direction of movement is along the optical axis.

Instead of applying an inverse filter in the frequency domain, it is possible to use digital image restoration techniques in the spatial domain, for example by convolution or the use of unsharp masks.

1. A method of stereo microscopy using an apparatus including a microscope, a sample holder located in the vicinity of the focal point of the microscope, drive means for providing relative movement between the sample holder and the focal point, an image gathering device arranged to collect microscopic images of objects at the focal point of the microscope, an image processing device and a display device, wherein first and second microscopic images of an object in the sample holder are gathered by the image gathering device by means of first and second sequential exposures, relative movement between the sample holder and the focal point being provided in first and second directions during said first and second exposures respectively, the first and second images are processed by the image processing device, and the processed first and second images are displayed substantially simultaneously by the displays device for viewing separately by the left and right eyes respectively of an observer.

2. A method according to claim 1, in which said first and second directions of relative movement are non-parallel.

3. A method according to claim 2, in which said first and second directions of relative movement are inclined at an angle β in the range 0° to 20°, preferably 5° to 15°, more preferably approximately 10°.

4. A method according to claim 3, in which the angle β is adjustable.

5. A method according to any one of the preceding claims, in which each of said first and second directions includes a component in the axial direction of the microscope.

6. A method according to claim 5, in which relative movement in the axial direction is provided by moving the sample holder.

7. A method according to claim 5, in which relative movement in the axial direction is provided by moving the focal plane of the microscope.

8. A method according to any one of claims 5 to 7, in which the distance of relative movement in the axial direction is greater than the depth of field of the microscope.

9. A method according to any one of the preceding claims, in which at least one of said first and second directions includes a component in the lateral direction of the microscope.

10. A method according to claim 9, in which relative movement in the lateral direction is provided by moving the sample holder.

11. A method according to claim 9, in which relative movement in the lateral direction is provided by moving the optical axis of the microscope.

12. A method according to any one of claims 9 to 11, in which the distance of relative movement in the lateral direction is greater than the resolution of the microscope.

13. A method according to any one of the preceding claims, in which an inverse filtering process is applied to the first and second images.

14. A method according to claim 13, in which the inverse filtering process includes the steps of generating a Fourier transform of the image applying an inverse filter, and then generating an inverse Fourier transform.

15. A method according to claim 14, in which the inverse filter comprises a Wiener filter.

16. A method according to any one of claims 13 to 15, in which the inverse filtering process is carried out by means of a data processing device.

17. A method according to any one of claims 1 to 12, in which a digital image restoration process is applied to the first and second images.

18. A method according to any one of the preceding claims, in which relative movement between the sample holder and the focal point is controlled by a computer.

19. A method according to any one of the preceding claims, in which the processed first and second images are separated physically from one another for separate viewing.

20. A method according to any one of claims 1 to 18, in which the processed first and second images are separated optically from one another for separate viewing.

21. A method according to any one of claims 1 to 18, in which the processed first and second images are separated temporally from one another for separate viewing.

22. A stereo microscopy apparatus including a microscope, a sample holder located in the vicinity of the focal point of the microscope drive means for providing relative movement between the sample holder and the focal point, an image gathering device arranged to collect microscopic images of objects at the focal point of the microscope, an image processing device, a display device and a control device that is constructed and arranged to control operation of the apparatus, said control device being programmed such that during operation, first and second microscopic images of an object in the sample holder are gathered by the image gathering device by means of first and second sequential exposures, relative movement between the sample holder and the focal point is provided in first and second directions during said first and second exposures respectively the first and second images are processed by the image processing device, and the processed first and second images are displayed substantially simultaneously by the display device for viewing separately by the left and right eyes respectively of an observer.

23. An apparatus according to claim 22, in which the control device is programmed such that during operation, said first and second directions of relative movement are non-parallel.

24. An apparatus according to claim 23, in which said first and second directions of relative movement are inclined at an angle β, the apparatus including means for adjusting the angle β.

25. An apparatus according to any one of claims 22 to 24, including means for moving the sample holder.

26. An apparatus according to any one of claims 22 to 25, including means for moving the focal plane of the microscope.

27. An apparatus according to any one of claims 22 to 26, including means for moving the optical axis of the microscope.

28. An apparatus according to any one of claims 22 to 27, in which the image processing device is constructed and arranged to apples an inverse filtering process to the first and second images.

29. An apparatus according to any one of claims 22 to 27, in which the image processing device is constructed and arranged to apply a digital image restoration process to the first and second images.

30. An apparatus according to claim 28 or claim 29, in which the image processing device comprises a data processing device.

31. An apparatus according to any one of claims 22 to 30, in which the display device is constructed and arranged such that the processed first and second images are separated physically from one another for separate viewing.

32. An apparatus according to any one of claims 22 to 30 in which the display device is constructed and arranged such that the processed first and second images are separated optically from one another for separate viewing.

33. An apparatus according to any one of claims 29 to 30, in which the display device is constructed and arranged such that the processed first and second images are separated temporally from one another for separate viewing.
